(19) United States
(12) Patent Application Publication
(10) Pub. No.: US 2026/0163286 A1
(43) Pub. Date: Jun. 11, 2026

(54) CONNECTOR

(71) Applicant: SUMITOMO WIRING SYSTEMS, LTD., Mie (JP)

(72) Inventors: Liping KANG, Mie (JP); Shuhei SATO, Mie (JP)

(21) Appl. No.: 19/404,527

(22) Filed: Dec. 1, 2025

(30) Foreign Application Priority Data
Dec. 11, 2024 (JP) 2024-216213

(51) Int. Cl. H01R 13/428

(52) U.S. Cl. CPC H01R 13/428

(57) ABSTRACT

A terminal has an outer conductor that is a body portion whose axis is oriented in a front-rear direction, and a first protrusion having a shape obtained by bending a portion of the outer conductor outward in a radial direction, the portion extending rearward from a support end of the outer connector. A housing has a cavity that extends in the front-rear direction and in which the outer conductor is disposed, and a first recess that extends in the front-rear direction while in communication with the cavity and in which the first protrusion is disposed. The first recess has an inner back surface at a position recessed outward in the radial direction from an inner peripheral surface of the cavity.

### CROSS-REFERENCE TO RELATED APPLICATIONS

This application is based on and claims priority from Japanese Patent Application No. 2024-216213, filed on Dec. 11, 2024, with the Japan Patent Office, the disclosure of which is incorporated herein in its entirety by reference.

### TECHNICAL FIELD

The present disclosure relates to a connector.

### BACKGROUND

JP 2022-069162 A discloses a high-frequency connector including an inner terminal (hereinafter referred to as “terminal”) and an inner housing (hereinafter referred to as “housing”). The housing has an inner terminal storage chamber (hereinafter referred to as “cavity”) in which the terminal is stored from the rear. The rear end of the terminal has a cylindrical enlarged-diameter portion. An upright piece that protrudes to one side in a radial direction intersecting the front-rear direction is formed on the enlarged-diameter portion. A guide groove that is recessed to one side in the radial direction is formed in an inner peripheral surface of the cavity of the housing. The upright piece is fitted into the guide groove.

### SUMMARY

If the leading end of the upright piece comes into contact with the inner back surface of the guide groove, it may damage the inner back surface of the guide groove. For this reason, it is estimated that a clearance is formed between the leading end of the upright piece and the inner back surface of the guide groove to prevent the leading end of the upright piece from coming into contact with the inner back surface of the guide groove. However, if such a clearance is formed and there is looseness in the radial direction between the upright piece and the housing, the terminal will tilt to the other side in the radial direction by an amount corresponding to the amount of looseness, which creates a problem of not being able to ensure the stability of the orientation of the terminal in the housing.

In view of this, an object of the present disclosure is to provide a connector that can ensure the stability of the orientation of a terminal in a housing.

A connector of the present disclosure includes a terminal and a housing that stores the terminal, in which the terminal has a body portion whose axis is oriented in a front-rear direction, and a first protrusion having a shape obtained by bending a portion of the body portion outward in a radial direction, the portion extending rearward from a support end of the body portion, the housing has a cavity that extends in the front-rear direction and in which the body portion is disposed, and a first recess that extends in the front-rear direction while in communication with the cavity and in which the first protrusion is disposed, the first recess has an inner back surface at a position recessed outward in the radial direction from an inner peripheral surface of the cavity, and a top surface on an outer side in the radial direction of the first protrusion is curved and set to come into contact with the inner back surface of the first recess.

According to the present disclosure, it is possible to provide a connector that can ensure the stability of the orientation of a terminal in a housing.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a connector of a first embodiment.

FIG. 2 is a perspective view of a second outer conductor of a terminal in the connector of the first embodiment, as seen from the rear.

FIG. 3 is a perspective view of a housing in the connector of the first embodiment, as seen from the rear.

FIG. 4 is a plan cross-sectional view of the housing in the connector of the first embodiment.

FIG. 5 is a perspective view of a retainer in the connector of the first embodiment, as seen from the front.

FIG. 6 is a front view of the retainer in the connector of the first embodiment.

FIG. 7 is a rear view of the retainer in the connector of the first embodiment.

FIG. 8 is a rear view of the connector of the first embodiment.

FIG. 9 is a cross-sectional view of the connector of the first embodiment taken along line A-A in FIG. 8.

FIG. 10 is a cross-sectional view of the connector of the first embodiment, showing a state in which the retainer locks the terminal in a retained state.

FIG. 11 is a cross-sectional view of the connector of the first embodiment, showing a state in which protruding portions of the retainer are in contact with another side in the radial direction of an outer peripheral surface of the terminal.

FIG. 12 is a perspective view of a terminal in a connector of a second embodiment, as seen from below.

FIG. 13 is a cross-sectional view of the connector of the second embodiment, showing a state in which protruding portions of the terminal face a receiving surface of a receiving portion of a retainer in a contactable manner.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure will be listed and described.
(1) A connector of the present disclosure includes a terminal and a housing that stores the terminal, in which the terminal has a body portion whose axis is oriented in a front-rear direction, and a first protrusion having a shape obtained by bending a portion of the body portion outward in a radial direction, the portion extending rearward from a support end of the body portion, the housing has a cavity that extends in the front-rear direction and in which the body portion is disposed, and a first recess that extends in the front-rear direction while in communication with the cavity and in which the first protrusion is disposed, the first recess has an inner back surface at a position recessed outward in the radial direction from an inner peripheral surface of the cavity, and a top surface on an outer side in the radial direction of the first protrusion is curved and set to come into contact with the inner back surface of the first recess.

According to the above configuration (1), it is possible to eliminate looseness between the top surface on the outer side in the radial direction of the first protrusion and the inner back surface of the first recess, and therefore it is possible to suppress the terminal from tilting to the other side in the radial direction due to the looseness, and ensure the stability of the orientation of the terminal in the housing. In particular, since the first protrusion is shaped such that the portion extending rearward from the support end of the body portion is bent outward in the radial direction, and the top surface on the outer side in the radial direction of the first protrusion has a curved shape, it is possible to avoid damage to the contact area between the top surface of the first protrusion and the inner back surface of the first recess.
(2) In the connector according to (1), it is preferable that the terminal has a second protrusion having a shape obtained by cutting a portion of the body portion spaced apart in a peripheral direction from the first protrusion and raising the portion outward in the radial direction, at a position spaced apart in the peripheral direction from the first recess, the housing has a second recess that extends in the front-rear direction while in communication with the cavity and in which the second protrusion is disposed, and an end surface on an outer side in the radial direction of the second protrusion is located away from an inner back surface of the second recess.

According to the above configuration (2), no contact resistance occurs due to contact between the end surface on the outer side in the radial direction of the second protrusion and the inner back surface of the second recess, and therefore even if the terminal has the first protrusion and the second protrusion, it is possible to avoid an increase in the resistance to insertion of the terminal into the cavity.
(3) In the connector according to (2), the end surface on the outer side in the radial direction of the second protrusion may be a cut surface. In the present disclosure, even if the end surface on the outer side in the radial direction of the second protrusion is a cut surface, it is possible to prevent the second protrusion from coming into contact with the inner back surface of the second recess, thereby avoiding a situation in which the inner back surface of the second recess is damaged.

### Details of Embodiments of Present Disclosure

Specific examples of the present disclosure will be described below with reference to the drawings. It should be noted that the present invention is not limited to the examples herein, but rather is indicated by the scope of the claims, and is intended to include all modifications within a meaning and scope equivalent to the scope of the claims.

### First Embodiment

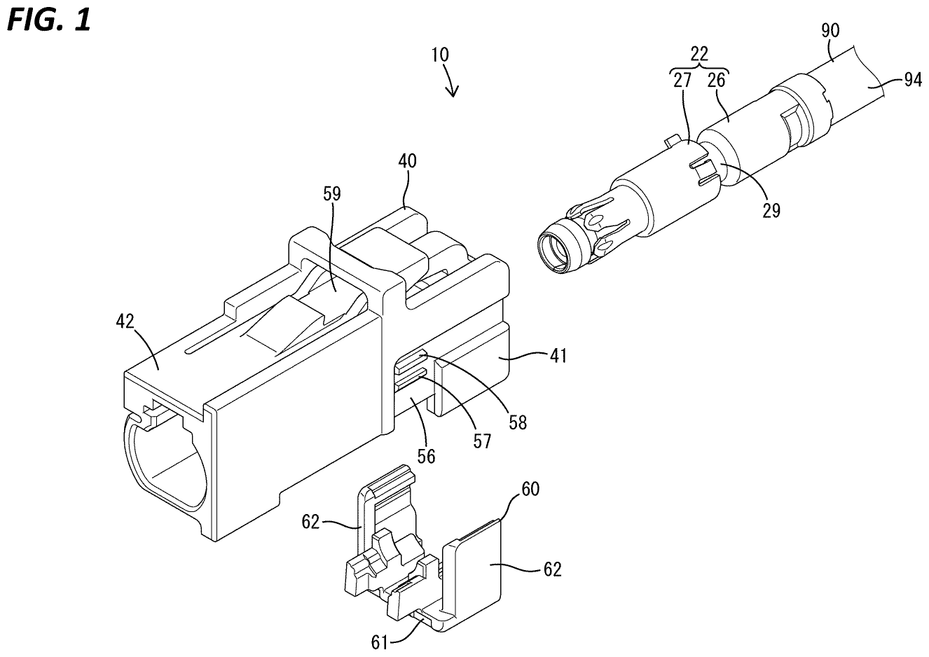

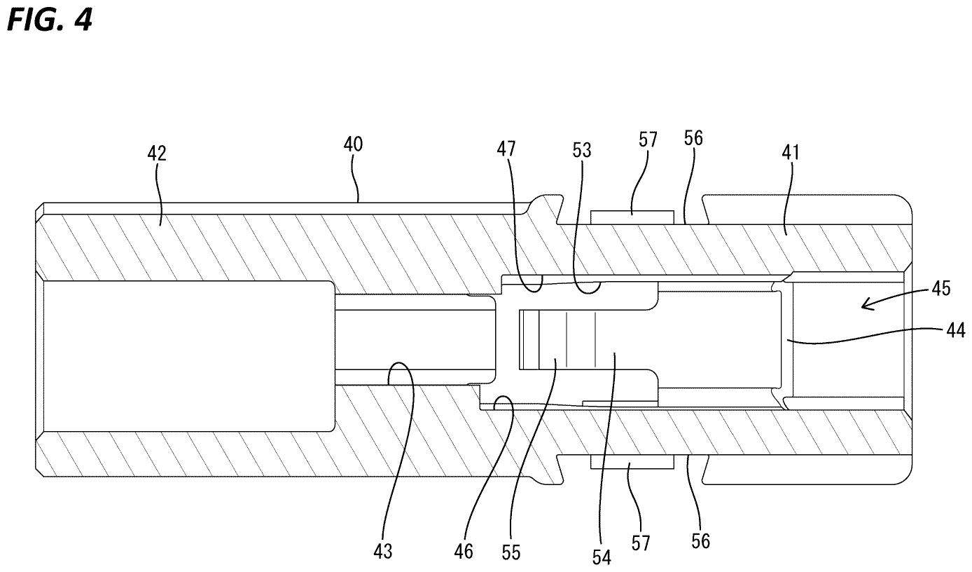

A connector 10 of a first embodiment is a shielded connector, and as shown in FIG. 1, includes a terminal 20 serving as a shield terminal connected to an end of a shielded electric wire 90. The connector 10 also includes a housing 40 that stores the terminal 20 and a retainer 60 that retains the terminal 20 in the housing 40. The housing 40 is capable of fitting with a partner connector (not shown). In the following description, with regard to the front-rear direction, the side of the housing 40 fitted with the partner connector will be referred to as the front side. The up-down direction is based on the up-down direction in the drawings except for FIG. 4. The reference for each direction does not necessarily coincide with the reference for each direction in a state where the connector 10 is mounted in a vehicle (not shown) or the like.

### Terminal 20 and Shielded Electric Wire 90

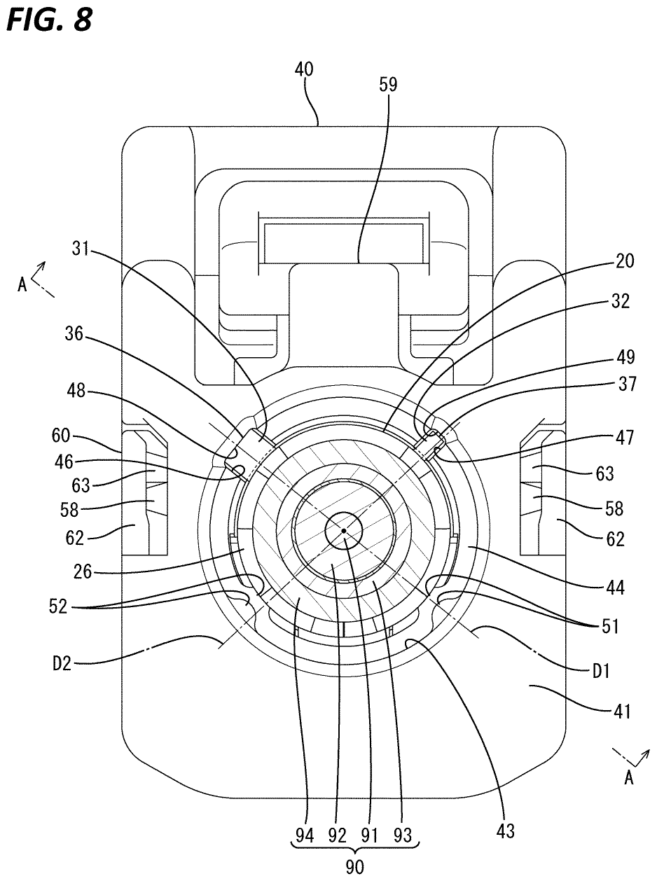

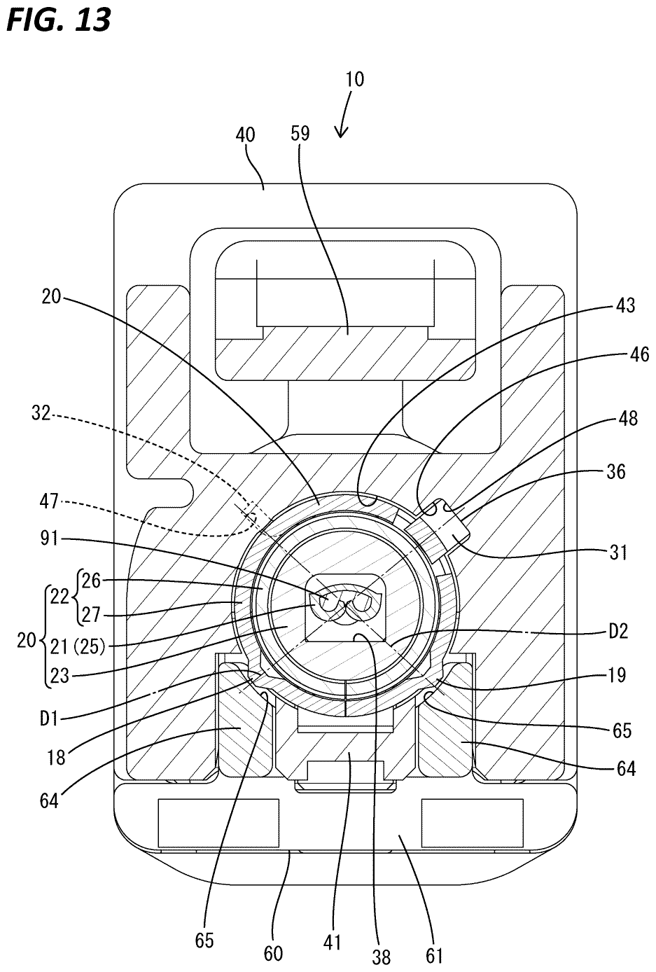

As shown in FIG. 1, the terminal 20 has a shape that extends in the front-rear direction as a whole. The terminal 20 has an inner conductor 21, an outer conductor 22, and a dielectric 23 (see FIG. 13 corresponding to a second embodiment described later). The inner conductor 21 is formed by performing bending or the like of a conductive metal plate material. The inner conductor 21 has a cylindrical connecting portion (not shown) and a crimped portion 25 that is continuous with the rear side of the connecting portion. The connecting portion is connected to a partner inner conductor (not shown). The crimped portion 25 is connected to a core wire 91 at the terminal end of the shielded electric wire 90 through crimping. As shown in FIG. 8, the shielded electric wire 90 is a coaxial wire and includes an insulating coating 92 that surrounds the outer periphery of the core wire 91, a braided wire 93 in the form of a mesh tube that surrounds the outer periphery of the coating 92, and an insulating sheath 94 that surrounds the outer periphery of the braided wire 93. The core wire 91 has the function of transmitting high-frequency signals. The braided wire 93 has the function of shielding electromagnetic waves.

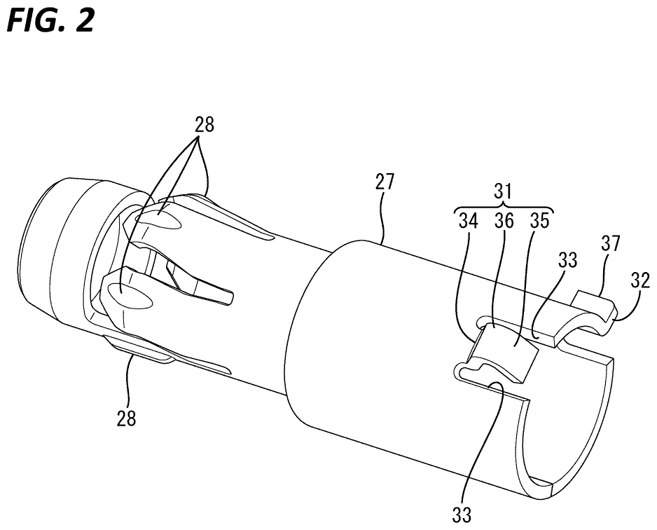

The outer conductor 22 is formed by bending a conductive metal plate material or the like. As shown in FIGS. 1 and 2, the outer conductor 22 has a first outer conductor 26 and a second outer conductor 27, which are separate from each other. The first outer conductor 26 and the second outer conductor 27 have a cylindrical shape whose axis oriented in the front-rear direction. The front end of the first outer conductor 26 is fitted into the rear end of the second outer conductor 27. The first outer conductor 26 and the second outer conductor 27 are coupled by welding, such as spot welding, performed at their fitting portions. The coupled first outer conductor 26 and second outer conductor 27 form a cylindrical body portion (corresponding to the outer conductor 22) extending in the front-rear direction.

As shown in FIG. 2, the front portion of the second outer conductor 27 is smaller in diameter than the rear portion of the second outer conductor 27. A plurality of contact portions 28 are formed at intervals in the peripheral direction on the outer peripheral surface of the front portion of the second outer conductor 27. A partner outer conductor (not shown) is fitted onto the front portion of the second outer conductor 27 from the front. When the contact portions 28 come into contact with the inner peripheral surface of the partner outer conductor, the outer conductor 22 and the partner outer conductor are electrically connected to each other. The rear end of the first outer conductor 26 is crimped and connected to the braided wire 93 of the shielded electric wire 90. The first outer conductor 26 has a constricted portion 29 having a shape whose diameter decreases inward in the radial direction between its rear end crimped to the braided wire 93 of the shielded electric wire 90 and its front end fitted onto the second outer conductor 27. When the terminal 20 is stored in the housing 40, a locking projection 55 of a lance 54 (described later) is inserted into and disposed within the constricted portion 29.

As shown in FIG. 2, the rear end of the second outer conductor 27 (corresponding to an intermediate portion in the front-rear direction of the outer conductor 22) has two protrusions 31 and 32 protruding outward in the radial direction. The two protrusions 31 and 32 are provided so as to protrude side by side on both the left and right sides (both sides in the peripheral direction) of the upper end of the outer peripheral surface of the second outer conductor 27. The front end of the first outer conductor 26 is disposed on the inner side in the radial direction of the two protrusions 31 and 32. One of the two protrusions 31 and 32 is the first protrusion 31 that functions as an erroneous insertion prevention portion, and the other is the second protrusion 32 that functions as a rotation suppressing portion.

The first protrusion 31 is disposed on the outer peripheral surface of the second outer conductor 27 on one side of the uppermost end of the second outer conductor 27 (the left side in FIG. 2 when viewed from the rear). The first protrusion 31 is provided between a pair of peripheral slits 33 formed at the rear end of the second outer conductor 27, and has a shape that is bent outward in the radial direction. Specifically, the first protrusion 31 has a support end 34 that is located between the front ends of the slits 33 and continues from an adjacent portion of the second outer conductor 27, and a band-shaped extending portion 35 that extends rearward in a cantilever shape from the support end 34. The first protrusion 31 is formed by bending an extending portion 35 outward in the radial direction in a mountain shape at the front-rear intermediate portion. The bending direction (radial direction) of the first protrusion 31 is equivalent to the plate thickness direction of the first protrusion 31. The front and rear surfaces of the first protrusion 31 are plate surfaces of the first protrusion 31. A top surface 36 on the outside of the first protrusion 31 in the radial direction is also a plate surface and has a curved shape.

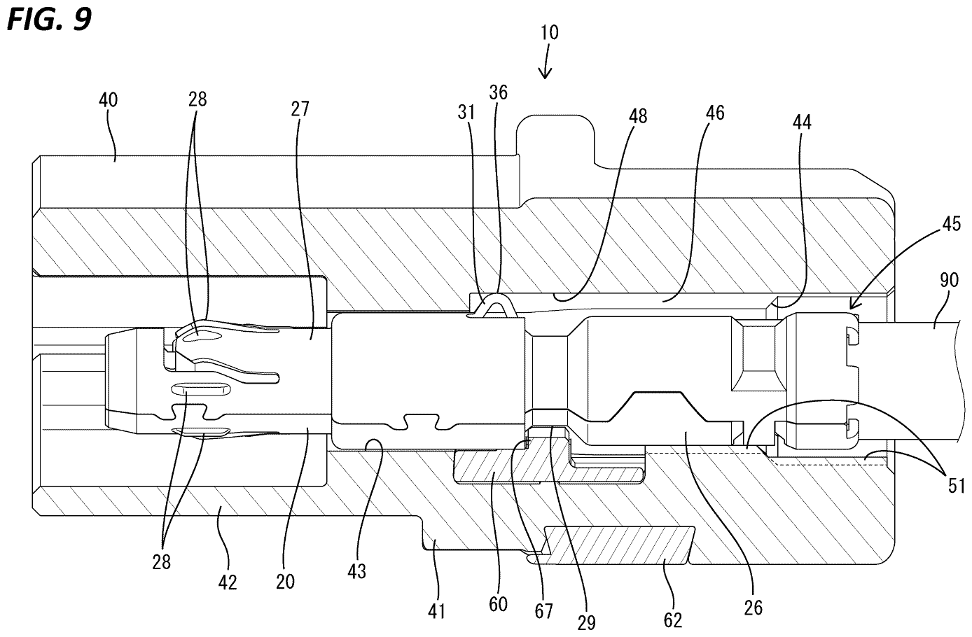

As shown in FIGS. 8 and 9, the first protrusion 31 is fitted into a first recess 46 (described later) of the housing 40. If the terminal 20 is in an incorrect orientation in the peripheral direction at the time of insertion into the housing 40, the first protrusion 31 is not positioned in correspondence with the first recess 46 but abuts against a step surface 44 (described later) of the housing 40. This prevents insertion of the terminal 20 in the incorrect orientation into the housing 40.

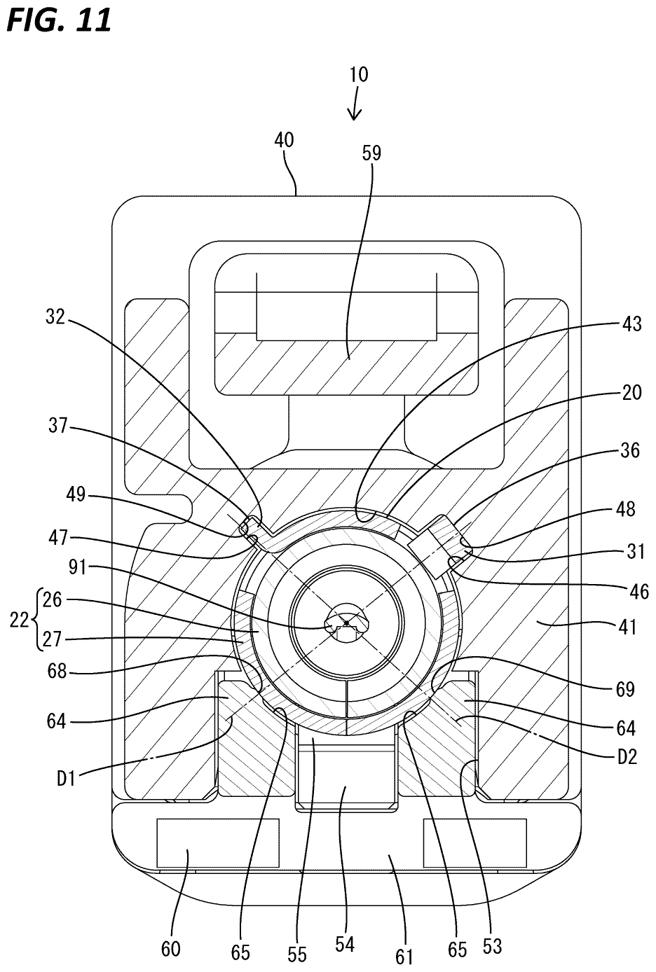

As shown in FIG. 2, the second protrusion 32 is disposed on the outer peripheral surface of the second outer conductor 27 on the other side of the uppermost end of the second outer conductor 27 (the right side in FIG. 2 when viewed from the rear). The second protrusion 32 is provided in a shape that protrudes outward in the radial direction by bending a portion of the rear end of the second outer conductor 27 along a fold in the front-rear direction. That is, the second protrusion 32 is formed by cutting and raising a portion of the rear end of the second outer conductor 27 outward in the radial direction. The plate surface of the second protrusion 32 is oriented in the peripheral direction. A leading end surface 37 of the second protrusion 32 (the leading end surface in the protruding direction and the end surface on the outer side in the radial direction) is a cut surface. As shown in FIGS. 8 and 11, the second protrusion 32 is fitted into a second recess 47 (described later) of the housing 40. The side surfaces on both sides in the peripheral direction of the second protrusion 32 come into contact with the inner surface in the peripheral direction of the second recess 47, thereby suppressing rotation of the terminal 20 around its axis in the housing 40.

The dielectric 23 is molded from an insulating synthetic resin material. The dielectric 23 is formed into a cylindrical shape whose axis is oriented in the front-rear direction as a whole. The dielectric 23 has a storage hole 38 (see FIG. 13) that extends in the axial direction. The inner conductor 21 is inserted into the storage hole 38 of the dielectric 23 from the rear and stored therein. The shielded electric wire 90 is arranged rearward of the dielectric 23 except for the leading end portion of the core wire 91 connected to the inner conductor 21. The inner conductor 21 and the outer conductor 22 are connected to each other in the insulated state by the dielectric 23 interposed therebetween.

### Housing 40

The housing 40 is molded from an insulating synthetic resin material. As shown in FIG. 1, the housing 40 has a housing body 41 and a hood portion 42 that protrudes forward from the housing body 41. As shown in FIG. 4, the housing body 41 has a cavity 43 that extends in the front-rear direction. As shown in FIG. 9, the terminal 20 is inserted into the cavity 43 from the rear.

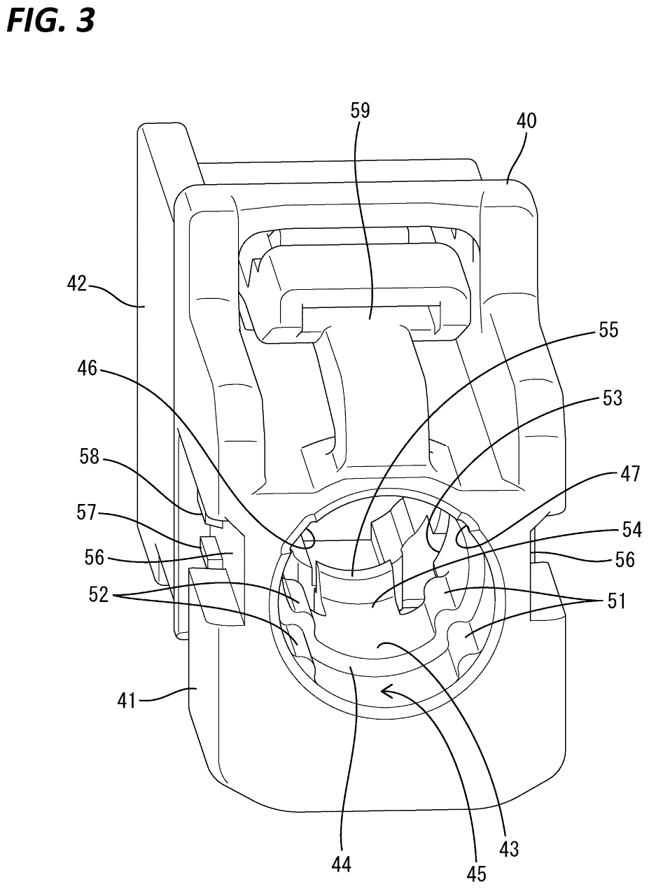

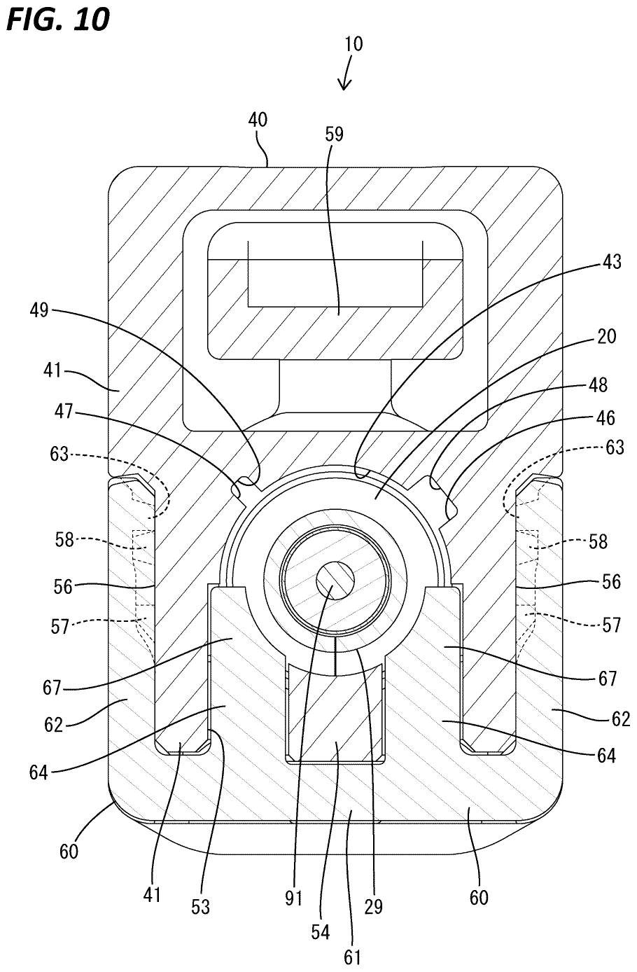

As shown in FIGS. 10 and 11, the cross-section of the inner peripheral surface of the cavity 43 (cross-section of the housing body 41 taken in a direction perpendicular to the front-rear direction) has a circular shape. As shown in FIGS. 3 and 4, the step surface 44 is formed on the inner peripheral surface of the cavity 43 near the rear end. As shown in FIG. 9, the step surface 44 is inclined inward in the radial direction on the inner peripheral surface of the cavity 43. Of the two front and rear portions of the cavity 43 of the housing body 41 across the step surface 44, the rear end portion on the rear side is formed larger in diameter than the front portion on the front side. The interior of the rear end portion of the cavity 43 forms a receiving space 45 for receiving the terminal 20.

As shown in FIGS. 3 and 10, the two recesses 46 and 47 are formed on the inner peripheral surface of the cavity 43. The two recesses 46 and 47 are provided in a recessed state side by side on both left and right sides (both sides in the peripheral direction) of the upper end of the inner peripheral surface of the cavity 43. As shown in FIG. 11, one of the two recesses 46 and 47 is configured as the first recess 46 that receives the first protrusion 31, and the other is configured as the second recess 47 that receives the second protrusion 32.

The first recess 46 is arranged at the upper end portion of the inner peripheral surface of the cavity 43, on one side of the uppermost end of the inner peripheral surface (the left side in FIG. 10 when viewed from the rear). As shown in FIG. 4, the first recess 46 has a groove shape that extends in the front-rear direction, with its rear end opened to the rear surface of the housing body 41 and its front end closed at a position near the front end of the housing body 41 (a position forward of the lance 54 described later).

In the first recess 46 extending in the front-rear direction, a portion formed at the rear end of the cavity 43 (a portion facing the receiving space 45) has a shallower radial depth (recess amount) than a portion formed at the front of the cavity 43. The first recess 46 is open to the step surface 44 at a position near the rear end. As shown in FIG. 10, the first recess 46 has an inner back surface 48 that is recessed outward in the radial direction from the inner peripheral surface of the cavity 43. The inner back surface 48 of the first recess 46 is oriented inward in the radial direction and is arranged in a direction parallel to a tangent to the inner peripheral surface of the cavity 43 and along the front-rear direction. As shown in FIG. 11, the top surface 36 of the first protrusion 31 can come into surface contact with the inner back surface 48 of the first recess 46.

As shown in FIG. 10, the second recess 47 is arranged at the upper end of the inner peripheral surface of the cavity 43, on the other side of the uppermost end of the inner peripheral surface (left side in FIG. 10 when viewed from the rear). As shown in FIG. 4, the second recess 47 has a groove shape extending in the front-rear direction, with its rear end open to the rear surface of the housing body 41 and its front end closed at a position near the front end of the housing body 41 (a position frontward of the lance 54). The first recess 46 and the second recess 47 are arranged parallel to each other with a gap left therebetween in the peripheral direction. The front end of the second recess 47 is located further frontward than the front end of the first recess 46.

In the second recess 47 extending in the front-rear direction, a portion formed at the rear end of the cavity 43 has a radial depth shallower than a portion formed at the front portion of the cavity 43. The second recess 47 is open to the step surface 44 at a position near the rear end. As shown in FIG. 10, the second recess 47 has an inner back surface 49 arranged in a direction parallel to a tangent to the inner peripheral surface of the cavity 43 and along the front-rear direction. The inner back surface 49 of the second recess 47 has an opening width in the peripheral direction smaller than that of the inner back surface 48 of the first recess 46.

A plurality of protrusion-shaped portions 51 and 52 are formed at intervals in the peripheral direction on the inner peripheral surface of the cavity 43. The protrusion-shaped portions 51 and 52 are arranged side by side on both the left and right sides (both sides in the peripheral direction) of the lower end of the inner peripheral surface of the cavity 43, and protrude in a fixed state. Some of the protrusion-shaped portions 51 and 52 are configured as first protrusion-shaped portions 51 arranged on the side opposite to the first recess 46 in the radial direction, and the others are configured as second protrusion-shaped portions 52 arranged on the side opposite to the second recess 47 in the radial direction.

As shown in FIG. 8, the first protrusion-shaped portions 51 are arranged at the lower end of the inner peripheral surface of the cavity 43 on the other side of the lowest end of the inner peripheral surface (the right side in FIG. 8 when viewed from the rear). The second protrusion-shaped portions 52 are arranged at the lower end of the inner peripheral surface of the cavity 43 on one side of the lowest end of the inner peripheral surface (the left side in FIG. 8 when viewed from the rear). The first protrusion-shaped portions 51 and the second protrusion-shaped portions 52 have the same shape.

As shown in FIG. 3, the first protrusion-shaped portions 51 and the second protrusion-shaped portions 52 each have a rib shape extending in the front-rear direction, with its rear end facing the rear surface of the housing body 41 and its front end reaching the rear end of an attachment hole 53 (described later). The peripheral surfaces of the protrusion-shaped portions 51 and 52 are arc-shaped in cross-section and connect in a curve to the inner peripheral surface of the adjacent cavity 43. The protrusion-shaped portions 51 and 52 are divided into front and rear portions by the step surface 44. The front protrusion-shaped portions 51 and 52 and the rear protrusion-shaped portions 51 and 52 are formed with the same protruding dimension with the step surface 44 therebetween. In the cavity 43, the forming ranges of the protrusion-shaped portions 51 and 52 in the front-rear direction and the forming ranges of the recesses 46 and 47 in the front-rear direction overlap each other.

As shown in FIG. 8, the first protrusion-shaped portions 51 and the first recess 46 are arranged side by side on one virtual diagonal line D1 passing through the center of the cavity 43 when viewed from the rear. The second protrusion-shaped portions 52 and the second recess 47 are arranged side by side on another virtual diagonal line D2 passing through the center of the cavity 43 when viewed from the rear. The first protrusion-shaped portions 51 and the second recess 47 are arranged side by side on one virtual vertical line extending in an up-down direction when viewed from the rear. The second protrusion-shaped portions 52 and the first recess 46 are arranged side by side on another virtual vertical line extending in the up-down direction when viewed from the rear. The first recess 46 and the second recess 47 are arranged side by side on one virtual horizontal line extending in a left-right direction when viewed from the rear. The first protrusion-shaped portions 51 and the second protrusion-shaped portions 52 are arranged side by side on another virtual horizontal line extending in the left-right direction when viewed from the rear.

As shown in FIGS. 4, 10, and 11, the housing body 41 has the attachment hole 53 that intersects the cavity 43. The attachment hole 53 is formed from the lower surface of the housing body 41 to an intermediate portion in the front-rear direction of the cavity 43. In short, the attachment hole 53 penetrates in the up-down direction through the lower wall of the housing body 41. The retainer 60 is inserted into the attachment hole 53 from below the housing body 41. The lance 54 is formed on the lower wall of the housing body 41. As shown in FIG. 4, the lance 54 faces the attachment hole 53 and defines an intermediate portion in the left-right direction of the attachment hole 53. The lance 54 is elastically deformable in the up-down direction, with its base corresponding to the rear end of the attachment hole 53 serving as a fulcrum. The locking projection 55 is formed at the leading end (front end) of the lance 54 and protrudes from an intermediate portion in the left-right direction in the cavity 43. The locking projection 55 faces the rear end of the second outer conductor 27 in a lockable manner.

As shown in FIGS. 3 and 4, the housing body 41 has side surfaces 56 extending in the front-rear and up-down directions on the left and right sides of the outer surface. The side surfaces 56 are recessed by one step from adjacent portions of the outer surface on the left and right sides of the housing body 41. As shown in FIG. 1, temporary locking portions 57 and full locking portions 58 are formed protruding from the side surfaces 56. The temporary locking portions 57 and the full locking portions 58 each have a rib shape extending in the front-rear direction. The temporary locking portions 57 and the full locking portions 58 are arranged side by side with each other in the up-down direction. The full locking portions 58 are located above the temporary locking portions 57. The temporary locking portions 57 and the full locking portions 58 function to hold the retainer 60 in a temporary locking position and a full locking position relative to the housing 40.

As shown in FIG. 1, the housing 40 has an elastically deformable locking arm 59 formed on the top surface. The locking arm 59 extends in the front-rear direction from the hood portion 42 to the housing body 41. The locking arm 59 functions to lock the partner connector and maintain the connector 10 and the partner connector in a fitted state. The front end of the cavity 43 is open to the inner end surface (the surface facing frontward at the rear) of the hood portion 42. The partner connector is fitted in the hood portion 42.

### Retainer 60

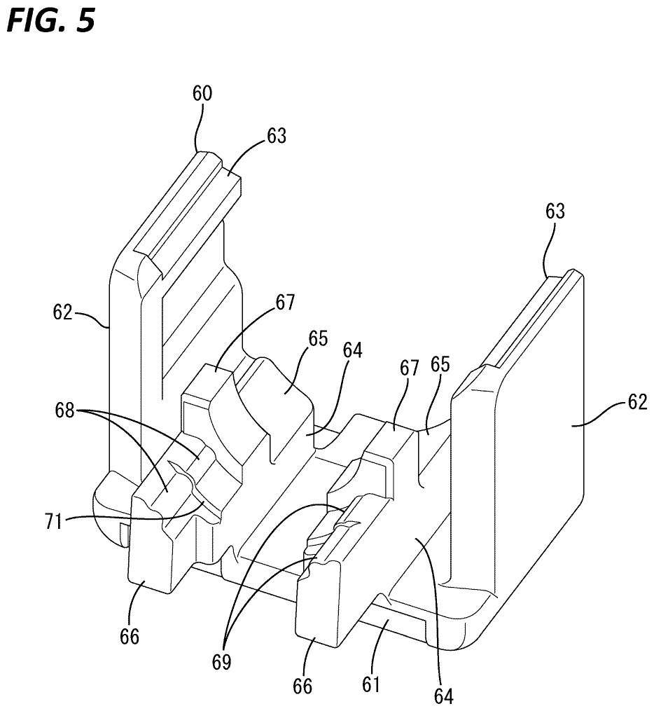

The retainer 60 is molded from an insulating synthetic resin material. As shown in FIGS. 5 to 7, the retainer 60 has a plate-like base portion 61 that is rectangular in bottom view and a pair of left and right side portions 62 that rise from both left and right ends of the base portion 61. Each side portion 62 has a rectangular plate shape in side view. The retainer 60 is arranged relative to the housing 40 so as to be movable between the temporary locking position and the full locking position. When the retainer 60 is in the temporary locking position, the lower surface of the base portion 61 is arranged lower than the lower surface of the rear portion of the housing body 41. When the retainer 60 is in the full locking position, the lower surface of the base portion 61 is arranged at the same position in the up-down direction (at the same height) as the lower surface of the rear portion of the housing body 41.

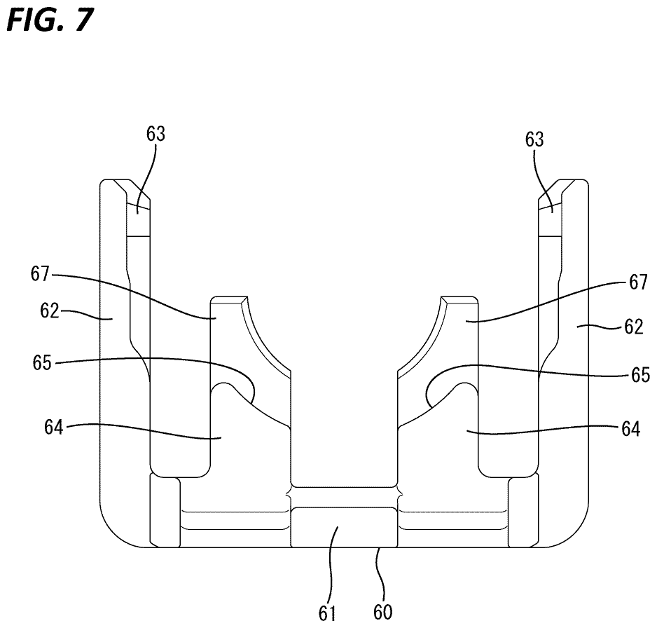

As shown in FIG. 10, the side portions 62 are arranged to cover the side surfaces 56 in the full locking position. As shown in FIGS. 5 and 7, a pair of left and right holding projections 63 are formed to protrude from the inner surfaces (mutually facing surfaces) of the upper ends of the side portions 62. The holding projections 63 have a rib shape that extends in the front-rear direction on the inner surfaces of the upper ends of the side portions 62. The holding projections 63 are arranged between the temporary locking portions 57 and the full locking portions 58, whereby the retainer 60 is held in the temporary locking position relative to the housing 40. As shown in FIG. 10, the holding projections 63 are arranged above the full locking portions 58, and the base portion 61 abuts against an intermediate portion in the front-rear direction of the housing body 41 (including the lower surface of the lance 54) from below, whereby the retainer 60 is held in the full locking position relative to the housing 40. The lance 54 is covered with the base portion 61 to suppress its excessive downward deflection.

As shown in FIGS. 5 to 7, the retainer 60 has a pair of left and right receiving portions 64 protruding from the upper surface of the base portion 61 on both the left and right sides. The receiving portions 64 are arranged so as to face the outer peripheral surface of the outer conductor 22 from below. The upper end surfaces of the receiving portions 64 form receiving surfaces 65 that curve in an arc along the outer peripheral surface of the outer conductor 22. The receiving portions 64 are wall-shaped with a wall surface oriented in the left-right direction. The receiving portions 64 face the side portions 62 in parallel with and spaced apart from the side portions 62 on the inner side in the left-right direction. As shown in FIG. 5, the receiving portions 64 have a pair of left and right protruding pieces 66 that protrude frontward from the base portion 61.

The receiving portions 64 have a pair of left and right retaining portions 67 formed to protrude from the front-rear intermediate portions of the receiving surfaces 65. The front surfaces of the retaining portions 67 are arranged along the up-down direction. The front surfaces of the retaining portions 67 face the rear end of the second outer conductor 27 in a lockable manner in the full locking position. The upper end surfaces of the retaining portions 67 are curved in an arc along the outer peripheral surface of the constricted portion 29 of the first outer conductor 26.

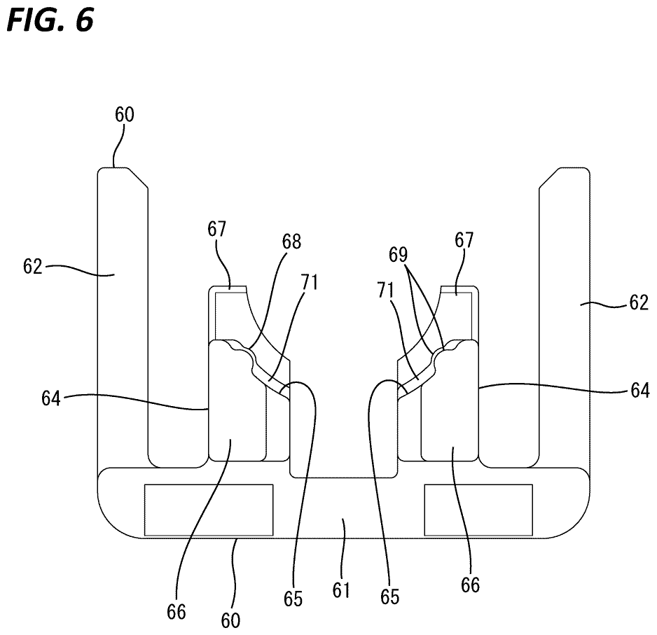

As shown in FIGS. 5 and 6, a plurality of protruding portions 68 and 69 are provided in a fixed state on the receiving surfaces 65 of the receiving portions 64. The protruding portions 68 and 69 have a rib shape that extends in the front-rear direction at intermediate portions in the left-right direction of the receiving surfaces 65. The rear ends of the protruding portions 68 and 69 are continuous with the front surfaces of the retaining portions 67. The front ends of the protruding portions 68 and 69 face the front end surfaces of the protruding pieces 66. Except for their rear ends, the protruding portions 68 and 69 are provided on the receiving surfaces 65 of the protruding pieces 66. The peripheral surfaces of the protruding portions 68 and 69 have an arc-shaped cross-section. The protruding pieces 66 have steps 71 formed near the bases thereof. The protruding portions 68 and 69 are arranged such that, on both the front and rear sides of the steps 71, the upper ends of the protruding portions 68 and 69 positioned on the front side are one step lower than the upper ends of the protruding portions 68 and 69 positioned on the rear side. The protruding portions 68 and 69 are provided rearward of the retaining portions 67. When the retainer 60 is held in the housing 40, the formation range of the protruding portions 68 and 69 in the front-rear direction and the formation range of the recesses 46 and 47 in the front-rear direction overlap each other.

When the retainer 60 is arranged in the full locking position relative to the housing 40, of the protruding portions 68 and 69, the ones on one side are configured as the first protruding portions 68 arranged on the side opposite to the first recess 46 in the radial direction, and the ones on the other side are configured as the second protruding portions 69 arranged on the side opposite to the second recess 47 in the radial direction.

As shown in FIG. 11, when the retainer 60 is arranged in the full locking position relative to the housing 40, the first protruding portions 68 and the first recess 46 are arranged side by side on the one virtual diagonal line D1 passing through the center of an intermediate portion in the front-rear direction of the cavity 43. The second protruding portions 69 and the second recess 47 are arranged side by side on the other virtual diagonal line D2 passing through the center of the intermediate portion in the front-rear direction of the cavity 43. The first protruding portions 68 and the second recess 47 are arranged side by side on one virtual vertical line along the up-down direction. The second protruding portions 69 and the first recess 46 are arranged side by side on another virtual vertical line along the up-down direction. The first recess 46 and the second recess 47 are arranged side by side on one virtual horizontal line along the left-right direction. The first protruding portions 68 and the second protruding portions 69 are arranged side by side on another virtual horizontal line along the left-right direction.

### Operation of Connector

During assembly, the retainer 60 is held in the temporary locking position relative to the housing 40, and the terminal 20 is inserted into the cavity 43. In the process of the insertion into the cavity 43, the first protrusion 31 is inserted into the first recess 46, and the second protrusion 32 is inserted into the second recess 47. The top surface 36 of the first protrusion 31 comes into contact with the inner back surface 48 of the first recess 46, and the first protrusion 31 elastically deforms slightly with the support end 34 side as a fulcrum. The leading end surface 37 of the second protrusion 32 is arranged away from the inner back surface 49 of the second recess 47 in a contactless manner. Both side surfaces in the peripheral direction of the second protrusion 32 are positioned so as to be able to come into contact with the inner surface of the second recess 47. Both side surfaces in the peripheral direction of the first protrusion 31 are also arranged so as to be able to come into contact with the inner surface of the first recess 46. Due to the contact between each of the first protrusion 31 and the second protrusion 32 and the housing 40 (the inner surfaces of the first recess 46 and the second recess 47), the terminal 20 is subjected to a force of pressing the outer conductor 22 to the other side in the radial direction (the lower side in the drawing) opposite to the one side in the radial direction (the upper side in the drawing) of the cavity 43 where the first protrusion 31 and the second protrusion 32 are arranged. When the terminal 20 receives this force, the outer conductor 22 attempts to move (hereinafter referred to as “deviation”) in a direction biased toward the other side in the radial direction. Then, the first protrusion-shaped portions 51 and the second protrusion-shaped portions 52 come into contact with the outer peripheral surface of the second outer conductor 27 of the outer conductor 22 from the other side in the radial direction, thereby preventing deviation of the outer conductor 22 toward the other side in the radial direction (see FIGS. 8 and 9). In the first embodiment, the first recess 46 and the first protrusion-shaped portions 51 are arranged on the one virtual diagonal line D1 when viewed from the rear, and the second recess 47 and the second protrusion-shaped portions 52 are arranged on the other virtual diagonal line D2 when viewed from the rear. Therefore, the force of pressing the outer conductor 22 to the other side in the radial direction is effectively received by the first protrusion-shaped portions 51 and the second protrusion-shaped portions 52. Accordingly, the outer conductor 22 is inserted straight into the cavity 43 along the front-rear direction.

On the other hand, if the terminal 20 is in an incorrect orientation in the peripheral direction, such as being upside down, the front end of the outer conductor 22 enters the receiving space 45 and the front surface of the first protrusion 31 abuts against the step surface 44, preventing the terminal 20 in the incorrect orientation from being inserted into the cavity 43. In the first embodiment, if the terminal 20 is in an incorrect orientation, the top surface 36 of the first protrusion 31 slides over the upper ends of the rear first protrusion-shaped portions 51, and one side of the outer peripheral surface of the outer conductor 22 in the radial direction comes into contact with the inner peripheral surface of the rear end side of the cavity 43 while receiving the elastic reaction force of the first protrusion 31. Accordingly, the front end of the outer conductor 22 can move through the receiving space 45 in the front-rear direction without tilting, thereby reliably ensuring that the front surface of the first protrusion 31 abuts against the step surface 44.

When the outer conductor 22 is properly inserted into the cavity 43, the locking projection 55 of the lance 54 enters the constricted portion 29 and faces the rear end of the second outer conductor 27 in a lockable manner. This primarily suppresses the terminal 20 from coming out rearward from the cavity 43. The first and second protrusions 31 and 32 are respectively positioned at the front ends (leading ends in the insertion direction) of the first and second recesses 46 and 47. In this state, the retainer 60 is moved to the full locking position relative to the housing 40. As shown in FIG. 9, when the retainer 60 reaches the full locking position, the retaining portions 67 enter the constricted portion 29 and face the rear end of the second outer conductor 27 in a lockable manner, thereby secondarily suppressing the terminal 20 from coming out rearward from the cavity 43.

Even when the retainer 60 is in the full locking position, due to the contact between the first and second protrusions 31 and 32 and the housing 40, the terminal 20 is subjected to a force causing the terminal 20 to deviate to the other side in the radial direction opposite to the side where the first and second protrusions 31 and 32 are arranged. In the first embodiment, as shown in FIG. 11, the other side . the lower side in FIG. 11) of the outer peripheral surface of the outer conductor 22 in the radial direction comes into contact with the first and second protruding portions 68 and 69 of the retainer 60, thereby preventing the outer conductor 22 from deviating to the other side in the radial direction. In particular, since the first recess 46 and the first protruding portions 68 are arranged on the one virtual diagonal line D1 and the second recess 47 and the second protruding portions 69 are arranged on the other virtual diagonal line D2, the force of pressing the outer conductor 22 to the other side in the radial direction is effectively received by the first and second protruding portions 68 and 69. Therefore, the terminal 20 is held in a position corresponding to the retainer 60 and in a state in which looseness is suppressed. As a result, positional fluctuation of the terminal 20 in the housing 40 can be suppressed to improve the shielding performance of the terminal 20.

As described above, the connector 10 of the first embodiment includes the housing 40, the terminal 20, and the retainer 60. The terminal 20 has the cylindrical outer conductor 22 (body portion) whose axis is oriented in the front-rear direction, and the protrusions 31 and 32 protruding from the outer conductor 22 to one side in the radial direction intersecting the front-rear direction. The housing 40 has the cavity 43 that extends in the front-rear direction and in which the terminal 20 is stored from the rear, the recesses 46 and 47 that are recessed on one side in the radial direction of the inner peripheral surface of the cavity 43 to fit to the protrusions 31 and 32, and the protrusion-shaped portions 51 and 52 that protrude in a fixed state from the other side in the radial direction of the inner peripheral surface of the cavity 43. With this configuration, when the terminal 20 is inserted into the cavity 43 and subjected to a force of pressing the terminal 20 to the other side in the radial direction from the portions on the sides of the protrusions 31 and 32 that are in contact with the inner surfaces of the recesses 46 and 47, the outer peripheral surface of the outer conductor 22 can come into contact with the protrusion-shaped portions 51 and 52 (see FIGS. 8 and 9). The contact of the outer peripheral surface of the outer conductor 22 with the protrusion-shaped portions 51 and 52 can suppress the terminal 20 from deviating to the other side in the radial direction and ensure the stability of the orientation of the terminal 20 in the housing 40.

The recesses 46 and 47 and the protrusion-shaped portions 51 and 52 are arranged on the inner peripheral surface of the cavity 43 having a circular cross-sectional shape, on the virtual diagonal lines D1 and D2 in the radial direction passing through the center of the cavity 43 when viewed from the rear (see FIG. 8). With this configuration, when the terminal 20 is subjected to a force of pressing the terminal 20 to the other side in the radial direction from the portions on the sides of the protrusions 31 and 32 that are in contact with the inner surfaces of the recesses 46 and 47, the outer peripheral surface of the outer conductor 22 can effectively come into contact with the protrusion-shaped portions 51 and 52 that face in the pressing direction. This suppresses tilting of the orientation of the terminal 20 more reliably.

The protrusions 31 and 32 include the first protrusion 31 and the second protrusion 32 that are arranged side by side in the peripheral direction on the outer peripheral surface of the outer conductor 22. The recesses 46 and 47 include, on the inner peripheral surface of the cavity 43, the first recess 46 that fits to the first protrusion 31 and the second recess 47 that fits to the second protrusion 32. The protrusion-shaped portions 51 and 52 include, on the inner peripheral surface of the cavity 43, the first protrusion-shaped portions 51 that are arranged alongside the first recess 46 on the one virtual diagonal line D1, and the second protrusion-shaped portions 52 that are arranged alongside the second recess 47 on the other virtual diagonal line D2. This suppresses tilting of the orientation of the terminal 20 more reliably.

In the first embodiment, the housing 40 has the attachment hole 53 that intersects an intermediate portion in the front-rear direction of the cavity 43 and in which the retainer 60 is stored from the other side in the radial direction. When stored in the attachment hole 53, the retainer 60 has the receiving portions 64 that face an intermediate portion in the front-rear direction of the terminal 20 from the other side in the radial direction, and the retaining portions 67 that protrude from the receiving portions 64 and lock an intermediate portion in the front-rear direction of the terminal 20. The receiving portions 64 of the retainer 60 have the protruding portions 68 and 69 that protrude to one side toward the terminal 20 in the radial direction.

When the terminal 20 stored in the cavity 43 is subjected to a force of pressing the terminal 20 to the other side in the radial direction from the portions on the sides of the protrusions 31 and 32 that are in contact with the inner surfaces of the recesses 46 and 47, the other side of the outer conductor 22 in the radial direction can come into contact with the protruding portions 68 and 69. Due to the contact between the other side in the radial direction of the outer conductor 22 and the protruding portions 68 and 69, it is possible to avoid deviation of the terminal 20 to the other side in the radial direction, and ensure the stability of the orientation of the terminal 20 in the housing 40.

Since the protruding portions 68 and 69 are arranged on the virtual diagonal lines D1 and D2 passing through the center of an intermediate portion in the front-rear direction of the cavity 43 and the recesses 46 and 47, when the terminal 20 is subjected to a force of pressing the terminal 20 to the other side in the radial direction from the portions on the sides of the protrusions 31 and 32 in contact with the inner surfaces of the recesses 46 and 47, the outer peripheral surface of the outer conductor 22 can come into contact with the protruding portions 68 and 69 in the pressing direction (see FIG. 11). This more reliably prevents the terminal 20 from deviating to the other side in the radial direction.

Furthermore, the protrusions 31 and 32 include the first protrusion 31 and the second protrusion 32 arranged side by side in the peripheral direction on the outer peripheral surface of the outer conductor 22. The recesses 46 and 47 include the first recess 46 into which the first protrusion 31 is fitted and the second recess 47 into which the second protrusion 32 is fitted. The protruding portions 68 and 69 include the first protruding portions 68 arranged on the one virtual diagonal line D1 passing through the center of an intermediate portion in the front-rear direction of the cavity 43 and the first recess 46, and the second protruding portions 69 arranged on the other virtual diagonal line D2 passing through the center of the intermediate portion in the front-rear direction of the cavity 43 and the second recess 47. With this configuration, it is possible to more reliably prevent the terminal 20 from deviating to the other side in the radial direction.

Further, as shown in FIG. 5, the protruding portions 68 and 69 are arranged side by side with the retaining portions 67 in the front-rear direction. Accordingly, even if the retainer 60 has the protruding portions 68 and 69 separately from the retaining portions 67, it is possible to avoid an increase in the size of the retainer 60 in the left-right direction, and ultimately it is possible to avoid an increase in the size of the connector 10 in the left-right direction.

In the first embodiment, the terminal 20 has the outer conductor 22 whose axis is oriented in the front-rear direction, and the first protrusion 31 formed by bending a portion of the outer conductor 22 extending rearward from the support end 34 to the outside in the radial direction. The housing 40 has the cavity 43 that extends in the front-rear direction and in which the outer conductor 22 is arranged, and the first recess 46 that extends in the front-rear direction while communicating with the cavity 43 and in which the first protrusion 31 is arranged. The first recess 46 has the inner back surface 48 that is recessed outward in the radial direction from the inner peripheral surface of the cavity 43. The top surface 36 of the first protrusion 31 is in contact with the inner back surface 48 of the first recess 46.

With the above-described configuration, as shown in FIG. 9, it is possible to eliminate looseness between the top surface 36 of the first protrusion 31 and the inner back surface 48 of the first recess 46, thereby suppressing deviation of the terminal 20 to the other side in the radial direction due to looseness and ensuring the stability of the orientation of the terminal 20 in the housing 40. In particular, as shown in FIG. 2, the first protrusion 31 has a shape in which the portion extending rearward from the support end 34 of the outer conductor 22 is bent outward in the radial direction, and the top surface 36 of the first protrusion 31 has a curved shape, and therefore it is possible to avoid damaging the contact portion between the top surface 36 of the first protrusion 31 and the inner back surface 48 of the first recess 46.

The terminal 20 also has the second protrusion 32 formed by cutting and raising a portion of the outer conductor 22 located away from the first protrusion 31 in the peripheral direction to the outside in the radial direction. At a position located away from the first recess 46 in the peripheral direction, the housing 40 has the second recess 47 that extends in the front-rear direction while being in communication with the cavity 43, and in which the second protrusion 32 is arranged. As shown in FIGS. 8 and 11, the leading end surface 37 of the second protrusion 32 is located away from the inner back surface 49 of the second recess 47. This causes no contact resistance due to the contact between the leading end surface 37 of the second protrusion 32 and the inner back surface 49 of the second recess 47. Therefore, even if the terminal 20 has the first protrusion 31 and the second protrusion 32, it is possible to avoid an increase in resistance to insertion of the terminal 20 into the cavity 43. In particular, even if the leading end surface 37 of the second protrusion 32 is a cut surface, it is possible to prevent the leading end surface 37 of the second protrusion 32 from coming into contact with the inner back surface 49 of the second recess 47, thereby avoiding a situation in which the inner back surface 49 of the second recess 47 is damaged.

### Second Embodiment

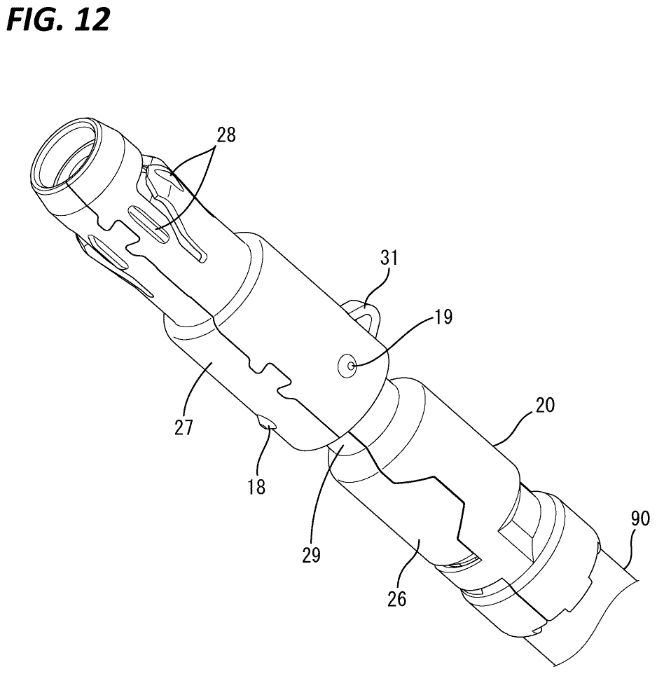

As shown in FIGS. 12 and 13, a connector 10 of a second embodiment is different from the connector of the first embodiment in that a retainer 60 is not provided with protruding portions 68 and 69, but a terminal 20 is provided with protruding portions 18 and 19. The other components are the same as those of the first embodiment.

The protruding portions 18 and 19 are provided so as to protrude as a pair with a gap therebetween in the peripheral direction on the lower end side of the rear end portion of a second outer conductor 27. That is, the protruding portions 18 and 19 are arranged at the rear end portion of the second outer conductor 27 on the side opposite to a first protrusion 31 and a second protrusion 32. The protruding portions 18 and 19 are provided in an embossed shape that bulges outward in the radial direction at the rear end portion of the second outer conductor 27. The protruding portions 18 and 19 have a circular outer shape when viewed from the outside in the radial direction. When a terminal 20 is inserted into a cavity 43 of a housing 40, the front-rear formation area of the protruding portions 18 and 19 and the front-rear formation area of recesses 46 and 47 overlap each other. Furthermore, when the terminal 20 is inserted into the cavity 43, with respect to virtual diagonal lines D1 and D2 that pass through the center of the left-right intermediate portion of the cavity 43, the protruding portions 18 and 19 include the first protruding portion 18 that is arranged side by side with the first recess 46 on one virtual diagonal line D1, and the second protruding portion 19 that is arranged side by side with the second recess 47 on the other virtual diagonal line D2.

As shown in FIG. 13, when the terminal 20 is inserted into the cavity 43 and the retainer 60 is held in the full locking position relative to a housing body 41, the leading ends of the first protruding portion 18 and the second protruding portion 19 on the outer side in the radial direction face, in a contactable manner, receiving surfaces 65 of protruding pieces 66 of receiving portions 64. The first protrusion 31 is inserted into the first recess 46 in a contactable manner, and the second protrusion 32 is inserted into the second recess 47 in a contactable manner on one side of the cavity 43 (upper side in FIG. 13) in the radial direction, and therefore the terminal 20 is subjected to a force causing the terminal 20 to deviate toward the other side of the cavity 43 (lower side in FIG. 13) in the radial direction. In the second embodiment, the first protruding portion 18 and the second protruding portion 19 come into contact with the corresponding receiving portions 64, thereby suppressing the deviation of the terminal 20 outward in the radial direction. As a result, it is possible to avoid looseness of the terminal 20 inserted in the cavity 43, and ensure the stability of the orientation of the terminal 20. In particular, since the first protruding portion 18 and the first recess 46 are arranged on one virtual diagonal line D1, and the second protruding portion 19 and the second recess 47 are arranged on the other virtual diagonal line D2, it is possible to more reliably prevent deviation of the terminal 20.

### Other Embodiments of Present Disclosure

The first and second embodiments disclosed herein should be considered illustrative in all respects and not restrictive.

In the first embodiment, the first protrusion-shaped portions and the second protrusion-shaped portions are formed in a rib shape extending in the front-rear direction, and the first protruding portions and the second protruding portions are formed in a rib shape extending in the front-rear direction. In contrast to this, according to another embodiment, a first protrusion-shaped portion and a second protrusion-shaped portion may be formed as projections at positions corresponding to a first recess and a second recess.

In the second embodiment, the first and second protruding portions are formed in a circular bulging shape on the outer conductor of the terminal. In contrast to this, according to another embodiment, first and second protruding portions may be formed in a rib shape extending in the front-rear direction on an outer conductor of a terminal.

In the first and second embodiments, the protrusion is constituted by a first protrusion and a second protrusion, and the recess is constituted by a first recess and a second recess. In contrast to this, according to another embodiment, a protrusion may be constituted by only a first protrusion, and a recess may be constituted by only a first recess.

In the first embodiment, the protruding portions are provided only on the retainer. In the second embodiment, the protruding portions are provided only on the terminal. In contrast to this, according to another embodiment, protruding portions may be provided on both a retainer and a terminal.

In the first embodiment, the terminal is a shield terminal having an inner conductor, an outer conductor, and a dielectric. In contrast to this, according to another embodiment, a terminal may be a general terminal that does not have a dielectric but is entirely constituted by a conductive metal plate material.

In the first embodiment, the protrusion-shaped portions are provided on the housing, and the protruding portions are provided on the retainer. In the second embodiment, the protruding portions are provided on the terminal. In contrast to this, according to another embodiment, a first protrusion may be set to come into contact with an inner back surface of a first recess, and when a terminal is subjected to a force causing the terminal to deviate to the other side in the radial direction, the other side of the outer peripheral surface of the terminal in the radial direction may come into contact with the other side of the inner peripheral surface of the housing in the radial direction or a receiving surface of a receiving portion of a retainer, thereby ensuring the stability of the orientation of the terminal. In this case, from the perspective of suppressing looseness of the terminal in the housing, for example, the housing may not be provided with protrusion-shaped portions, the retainer may not be provided with protruding portions, and the terminal may not be provided with protruding portions.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a terminal; and
a housing that stores the terminal,
wherein the terminal has:
a body portion whose axis is oriented in a front-rear direction; and
a first protrusion having a shape obtained by bending a portion of the body portion outward in a radial direction, the portion extending rearward from a support end of the body portion,
the housing has:
a cavity that extends in the front-rear direction and in which the body portion is disposed; and
a first recess that extends in the front-rear direction while in communication with the cavity and in which the first protrusion is disposed,
the first recess has an inner back surface at a position recessed outward in the radial direction from an inner peripheral surface of the cavity, and
a top surface on an outer side in the radial direction of the first protrusion is curved and set to come into contact with the inner back surface of the first recess.

2. The connector according to claim 1, wherein
the terminal has a second protrusion having a shape obtained by cutting a portion of the body portion spaced apart in a peripheral direction from the first protrusion and raising the portion outward in the radial direction,
at a position spaced apart in the peripheral direction from the first recess, the housing has a second recess that extends in the front-rear direction while in communication with the cavity and in which the second protrusion is disposed, and
an end surface on an outer side in the radial direction of the second protrusion is located away from an inner back surface of the second recess.

3. The connector according to claim 2, wherein the end surface on the outer side in the radial direction of the second protrusion is a cut surface.
